(19) United States
(12) Patent Application Publication
(10) Pub. No.: US 2003/0138530 A1
(43) Pub. Date: Jul. 24, 2003

(54) Individually quick-freeze-formed calamari rings

(76) Inventors: Michael G. Smith, Portsmouth, NH (US); Christian T. Callahan, Portsmouth, NH (US)

Correspondence Address: Richard C. Litman, LITMAN LAW OFFICES, LTD., P.O. Box 15035, Arlington, VA, 22215, US

(21) Appl. No.: 10/348,022

(22) Filed: Jan. 22, 2003

Related U.S. Application Data
(60) Provisional application No. 60/349,372, filed on Jan. 22, 2002.

(51) Int. Cl. A23B 4/00

(52) U.S. Cl. 426/129

(57) ABSTRACT

The production of a plurality of quickly frozen, natural, raw, and open calamari squid rings, and the product and the packaging thereof with either bread crumbs and/or flavoring.

### CROSS-REFERENCE TO RELATED APPLICATION

This application claims the benefit of U.S. Provisional Patent Application Serial No. 60/349,372, filed Jan. 22, 2002.

### BACKGROUND OF THE INVENTION

1. FIELD OF THE INVENTION

The present invention relates generally to manufactured food products. More specifically, the invention is a plurality of quickly frozen, natural, raw, and open Calamari squid rings and the packaging thereof with bread crumbs and/or flavoring agents.

2. DESCRIPTION OF RELATED ART

The relevant art of interest describes various food products which are frozen and packaged, but none discloses the present invention. There is a need for making available frozen, sliced and open squid rings with optional additional bread crumbs and/or flavoring agents for ease in eating raw or cooking as well as decreasing the manufacturing cost by increasing the yield by weight of the food product. The related art is as follows.

U.S. Pat. No. 2,822,274 issued on Feb. 4, 1958, to Beverly E. Williams describes a process for the preparation of squid fillets, seasoning, breading, and freezing the breaded fillet.

U.S. Pat. No. 3,034,906 issued on May 15, 1962, to Beverly E. Williams describes a process for skinning squids for the preparation of squid fillets.

U.S. Pat. No. 3,151,991 issued on Oct. 6, 1964, to Michael E. Evans et al. describes a method for cutting −18° C. frozen fish by a mechanical cutter.

U.S. Pat. No. 3,593,370 issued on Jul. 20, 1971, to James M. Lapeyre describes a method of butchering whole frozen tuna.

U.S. Pat. No. 4,436,759 issued on Mar. 13, 1984, to David M. Trilling et al. describes shaped gelled food products manufactured from comminuted, granulated or chopped foodstuffs such as vegetables, fruits, meats, and fish, and the manufacturing process.

U.S. Pat. No. 4,622,234 issued on Nov. 11, 1986, to Minoru Okada describes a process for preparing abalone and fish meat products by grinding with salt and the like to prepare a paste, frozen and heated to sterilize.

U.S. Pat. No. 4,701,339 issued on Oct. 20, 1987, to Jean-Louis Leuba et al. describes a method for dissolving squid membranes.

U.S. Pat. No. 4,859,478 issued on Aug. 22, 1989, to Jose M. I. Castro describes a process for manufacturing reconstituted squid in the form of rings. The eatable squid parts are washed and minced together at below zero temperatures. The pieces are compacted into ring-shaped molds. The rings are dipped into batter or bread crumbs and frozen.

U.S. Pat. No. 5,124,168 issued on Jun. 23, 1992, to Terri W. McMillin et al. describes a pasta product and the method of making it by mixing dried ingredients of flour, a monoglyceride with dried egg whites, olive oil, water, and flavoring compounds, and extruding the mixture under pressure.

U.S. Pat. No. 5,285,719 issued on Feb. 15, 1994, to David H. McFadden et al. describes a rapid frozen food thawing system.

U.S. Pat. No. 5,797,271 issued on Aug. 25, 1998, to Robert J. Darigo et al. describes a mobile brine tank quick-freezing system and method.

U.S. Pat. No. 5,817,353 issued on Oct. 6, 1998, to Nicholas A. Guarino describes a process and flat pack vacuum pallet packaging for shellfish and the like.

U.S. Pat. No. 5,955,131 issued on Sep. 21, 1999, to Yoshiyuki Fujita et al. describes a method of sandwiching soft and smooth fluid shrimp as a flat shape with uniform thickness.

U.S. Pat. No. 6,096,361 issued on Aug. 1, 2000, to Akiyoshi Yamane et al. describes a method for non-frozen preservation of fish and shellfish at a temperature below the freezing point.

Japan Patent Application No. 58-31967 published on Feb. 24, 1983, for Sueo Takahashi et al. describes the preparation of ring-shaped cuttlefish pieces by kneading the arms and fins with salt to obtain a meat paste, mixing the paste with seasoned chopped cooked squid, and punching into rings.

Japan Patent Application No. 58-40076 published on Mar. 8, 1983, for Jiyun Irie et al. describes a method for preventing the sticking or deformation of the opening of a cuttlefish cut in round slices by the heat and pressure of a retort after packing with a meat by dipping the round slices in an aqueous proteinic denaturing agent, i.e., alum or tannic acid, containing, packing with a meat, and then heated under pressure.

Japan Patent Application No. 3-10661 published on Jan. 18, 1991, for Shinichi Goto describes a preparation of ring-shaped torn and roasted cuttlefish by roasting cleaned but uncut cuttlefish between hot plates, rolling, and tearing the product.

Japan Patent Application No. 4-108364 published on Apr. 9, 1992, for Yutaka Kudo et al. describes a processed cuttlefish product by grinding the trunk meat, blending with wheat flour, starch and calcium hydroxide, and forming the blend into ribbons or rings.

Japan Patent Application No. 10-113150 published on May 6, 1998, for Koji Nakamura describes a process of cutting live squids into a continuous thin slice.

None of the above inventions and patents, taken either singly or in combination, is seen to describe the instant invention as claimed.

### SUMMARY OF THE INVENTION

The invention is a package of a plurality of quick-frozen, natural, raw, and open Calamari squid rings. Calamari squid rings for consumption are conventionally prepared by removing the body and cleaning, skinning, removing the wings, washing, slicing the body, and coating the slices with bread crumbs. However, this method is labor intensive and the product is not frozen. Another process comprises the obtaining of frozen cleaned squid which is further processed and is still labor intensive and costly. Yet another process comprises the blanching or partially cooking the squid rings which results in a significant loss of moisture in the final product.

Accordingly, it is a principal object of the invention to produce quick-frozen open Calamari squid rings.

It is another object of the invention to produce quickly frozen, open and natural Calamari squid rings.

It is a further object of the invention to produce quickly frozen, open, natural, and raw Calamari squid rings.

Still another object of the invention is to produce a package of quickly frozen, natural, raw, and open Calamari squid rings.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top plan view of a fresh Calamari squid being prepared by cutting off the head, wings and removing the entrails according to the present invention.

FIG. 2 is a top plan view of a cleaned squid tube with dashed cut lines evenly spaced.

FIG. 3 is a perspective view of a collapsed squid ring.

FIG. 4 is a perspective view of an open squid ring frozen on a male forming mold.

Similar reference characters denote corresponding features consistently throughout the attached drawings.

### DETAILED DESCRIPTION OF THE PREFERRED EMBODIMENT

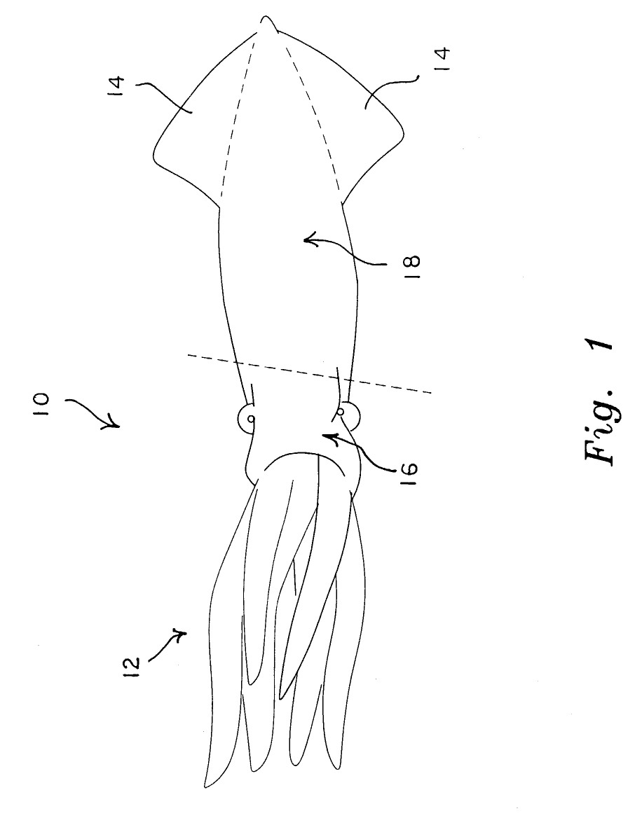

The present invention is directed to a quickly-frozen open and fresh Calamari squid ring product resulting in a lower cost-effective product with better flavor and texture. FIG. 1 illustrates a fresh whole squid 10 having tentacles 12, a pair of wings or fins 14, a head portion 16, and a body or tube portion 18.

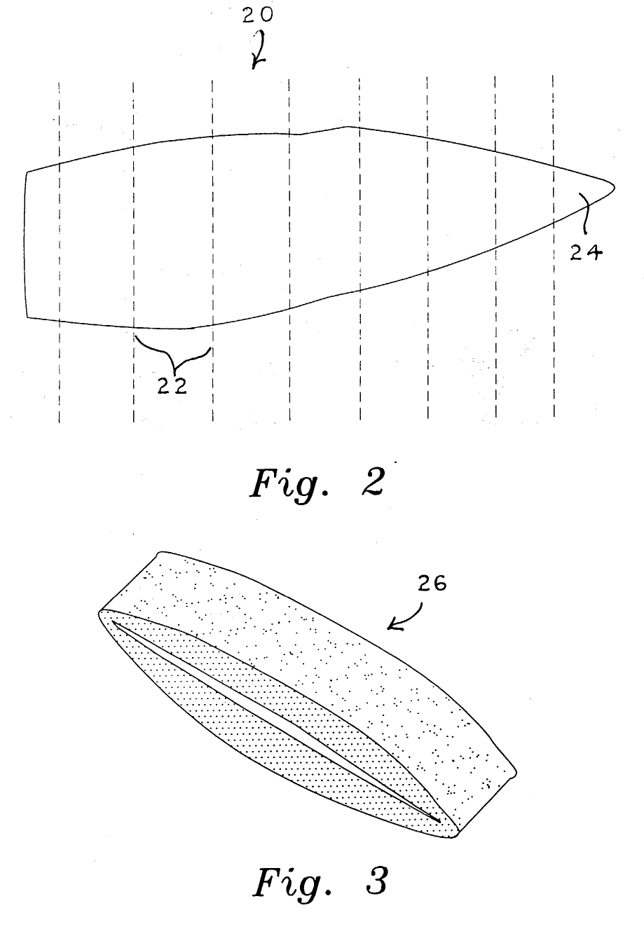

FIG. 2 shows the even slicing of a cleaned and washed squid tube 20 into slices 22 and a tube tip 24.

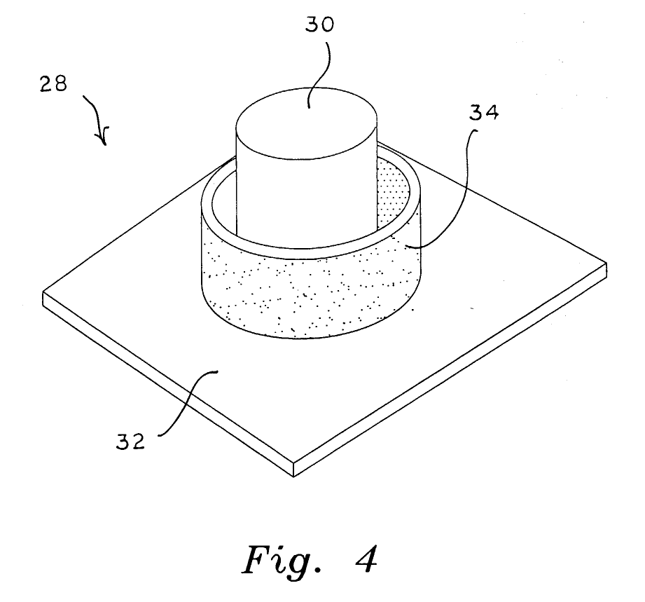

FIG. 3 depicts a typical fresh, flattened squid slice 26 having a typical width of approximately 50 mm.

FIG. 4 illustrates the individual quick freeze-formed Calamari squid ring 34 in an open condition by placing it on a male mold device 28. The mold 28 has a tapered round mold pin 30 on a flat mold base 32. The loose fit of the squid ring 34 on the mold pin 30 permits the squid ring 34 to adopt a natural appearance.

The round Calamari squid rings 34 can then be packaged in a sealed paper box or a transparent plastic bag for sale and use by the consumer. At the time of packaging, flavoring agents and/or bread crumbs may be added to the product.

It should be noted that this invention can be applied to other, related food products to produce an opened fresh product.

It is to be understood that the present invention is not limited to the sole embodiment described above, but encompasses any and all embodiments within the scope of the following claims.

We claim:

1. A package containing a plurality of quickly frozen fresh and open Calamari squid rings comprising:
a sealed package selected from the group consisting of a paper box and a transparent plastic bag; and
a plurality of quickly frozen, fresh, open, and clean Calamari squid rings contained in said sealed package.

2. The package of Calamari squid rings according to claim 1, wherein the squid rings are each approximately 50 mm. in width.

3. The package of Calamari squid rings according to claim 1, wherein the sealed package is a paper box.

4. The package of Calamari squid rings according to claim 1, wherein the sealed package is a transparent plastic bag.

5. The package of Calamari squid rings according to claim 1, wherein the sealed package contains squid rings covered with bread crumbs.

6. The package of Calamari squid rings according to claim 1, wherein the sealed package contains flavoring agents.
